(19) United States
(12) Patent Application Publication
(10) Pub. No.: US 2005/0249190 A1
(43) Pub. Date: Nov. 10, 2005

(54) Using a CCXML service node to provide call processing functionality for a parlay gateway

(76) Inventor: Oliver Birch, Annapolis, MD (US)

Correspondence Address: McGinn & Gibb, PLLC, Suite 304, 2568-A Riva Road, Annapolis, MD, 21401, US

(21) Appl. No.: 10/840,157

(22) Filed: May 6, 2004

(51) Int. Cl. H04L 12/66

(52) U.S. Cl. 370/352

(57) ABSTRACT

A method and structure for providing call control in a telephone network that begins by directing a telephone call from a signal switching point to a service node, forwarding a hypertext transfer protocol (HTTP) call control extensible markup language (CCXML) application request from the service node to a server and parlay gateway combination, and forwarding a request for instruction from the server and parlay gateway combination to a telephony application server. The telephony application server returns a routing requirement to the server and parlay gateway combination which, in turn, dynamically transforms the routing requirement into a CCXML routing application and forwards the CCXML routing application to the service node. The service node executes the CCXML routing application to route the telephone call.

### BACKGROUND OF THE INVENTION

1. Field of the Invention

The present invention generally relates to a method and system for providing call control in a telephone network, and more particularly to a system that includes a Parlay Gateway that interfaces with a service provider's network using a standard CCXML service node.

2. Description of the Related Art

Conventional Parlay architectures use an SS7/TCAP (Telecommunications Signaling System No. 7/Transaction Capabilities Application Part) connection to the STP (signal transfer point) to request call processing. This existing solution relies on the call processing functionality of the Parlay Gateway to be provided by the service provider's network equipment and for this functionality to be externally controllable by the Parlay Gateway. However, the service provider rarely has this capability because either it is not supported by their network equipment vendors or it is not affordable. This problem is made more severe due to the heterogeneous nature of most service providers' networks and the fact that these capabilities normally need to be available across their entire switching network. The invention described below addresses these concerns.

### SUMMARY OF THE INVENTION

This disclosure presents a method of providing call control in a telephone network that begins by directing a telephone call from a signal switching point to a service node, forwarding a hypertext transfer protocol (HTTP) call control extensible markup language (CCXML) application request from the service node to a server and parlay gateway combination, and forwarding a request for instruction from the server and parlay gateway combination to a telephony application server. The telephony application returns a routing requirement to the server and parlay gateway combination which, in turn, dynamically transforms the routing requirement into a CCXML routing application and forwards the CCXML routing application to the service node. The service node executes the CCXML routing application to route the telephone call.

The system that supports this methodology includes the service node, server and parlay gateway combination, and telephony application. Again, the service node is adapted to forward a hypertext transfer protocol (HTTP) call control extensible markup language (CCXML) application request to the server and parlay gateway combination The telephony application is adapted to supply a routing requirement to the server and parlay gateway combination. The server and parlay gateway combination dynamically transforms the routing requirement into a CCXML routing application and the service node is adapted to execute the CCXML routing application to route the telephone call.

The server and parlay gateway combination provides unique functionality that is independent of the call processing functionality of remaining elements of the telephone network. Further, the server and parlay gateway combination can function in heterogeneous environments and work with different types of service nodes. The server portion of the server and parlay gateway combination comprises a HTTP server. Signaling transfer points can be connected to the service switching point, but communications between the signal switching point and the server and parlay gateway combination bypass the signaling transfer points.

The solution provided by the invention allows a standard CCXML Service node to provide the call processing functionality required by a Parlay Gateway. The inventive system is not dependent on specific network equipment, allowing it to function in heterogeneous environments. The invention does not require the Service provider to have any special functionality beyond their basic call processing capability. The invention is not dependent on a specific type of network signaling, SS7, ISDN or CAS can be used. The cost of the inventive system is lower when compared to conventional systems, because providing the call processing functionality required by a Parlay Gateway ubiquitously is very expensive. Further, it is easy to invoke VoiceXML from a CCXML environment, which significantly simplifies User Interaction as defined in Parlay. The CCXML Service node can be leveraged in other non-Parlay applications, further reducing the solution infrastructure costs. Additionally, with the invention it is easier to implement a Parlay Gateway with standard CCXML rather than having to support a large number of SS7/TCAP varients that are usually specific to the network equipment vendor and country of deployment. The Parlay Gateway of the invention is less complex and less expensive as it uses a standard TCP/IP interface rather than supporting multiple, redundant, physical SS7 links.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a schematic diagram of a telephone network;

FIG. 2 is a schematic diagram of a telephone network;

FIG. 3 is a flowchart diagram illustrating the invention processing a telephone call;

FIG. 4 is a flowchart diagram illustrating the invention processing a telephone call; and

FIG. 5 is a flowchart diagram illustrating a preferred method of the invention.

### DETAILED DESCRIPTION OF PREFERRED EMBODIMENTS OF THE INVENTION

The present invention and the various features and advantageous details thereof are explained more fully with reference to the nonlimiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

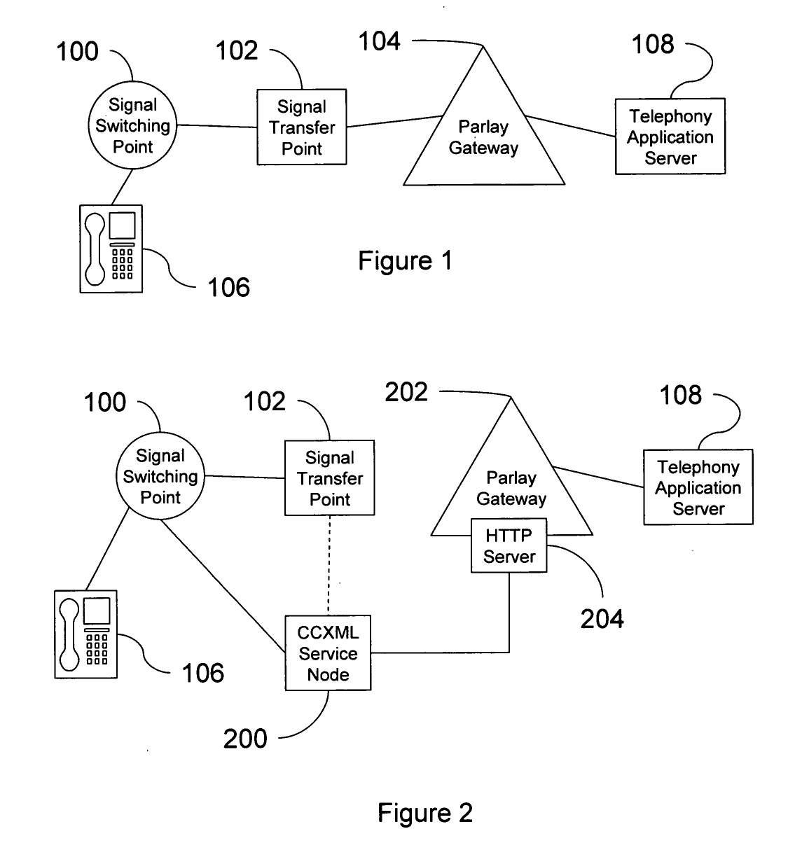

FIG. 1 is a block diagram that schematically illustrates a wired or wireless communication device 106 in a telephone network that is configured for provision of IN (Intelligent Network) services. While the communication device 106 shown in the drawings is a telephone, the invention is applicable to any device capable of voice communication, including but not limited to cellular phones, landline phones, wireless phones, voice enabled personal digital assistants (PDAs), voice enabled computers, etc. The telephone is directly or indirectly connected to a signal switching point 100, receiving signaling and voice communications from the communication device 106, and transferring the communications to other network elements in order to complete and carry out calls made by or to communication device 106.

The signal switching point 100 provides basic switching capabilities, including the means to establish, manipulate and release calls and connections. When signaling passing through the signal switching point 100 is related to an IN service, the call is suspended temporarily and control of the call is passed to the parlay gateway 104 through a signal transfer point (STP) 102. Communications between SSP 100 and the parlay gateway 104 are based on a standard IN Application Protocol (INAP). The parlay gateway 104 processes the call by operating in conjunction with the telephony application server 108 (which operates applications to instruct the parlay gateway 104 how to route the call). Then, the parlay gateway 104 sends instructions back via the signal transfer point 102 to the signal switching point 100 as to how the call should be handled.

One basic idea of IN is to move intelligent services out of the network switches to separate service points, such as the parlay gateway 104/telephony application server 108. Multiple parlay gateways may communicate with a given signal switching point, or the switch can be programmed to choose the parlay gateway for each call depending on the trigger parameters. Similarly, a single parlay gateway can communicate with and service multiple signal switching points (although not all the switches in a network are necessarily IN-enabled). The unified IN architecture allows different service providers to create parlay gateways that implement their own particular services, independent of the underlying network technology.

In the system shown in FIG. 1, call processing functionality required by the parlay gateway 108 must be provided by the service provider's network equipment. In addition, the service provider's network equipment must be modified to allow this functionality to be externally controllable by the Parlay Gateway. However, the service provider rarely has this capability because either it is not supported by their network equipment vendors or it is not affordable. This problem is made more severe due to the heterogeneous nature of most service providers' networks and the fact that these capabilities normally need to be available across their entire switching network.

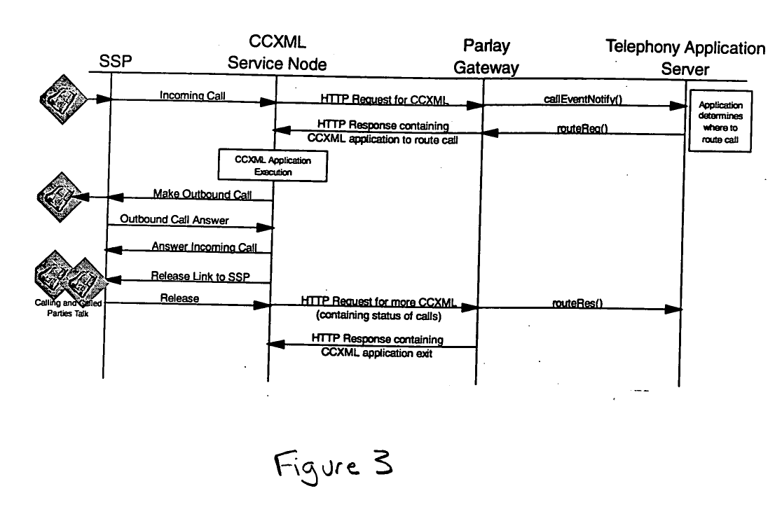

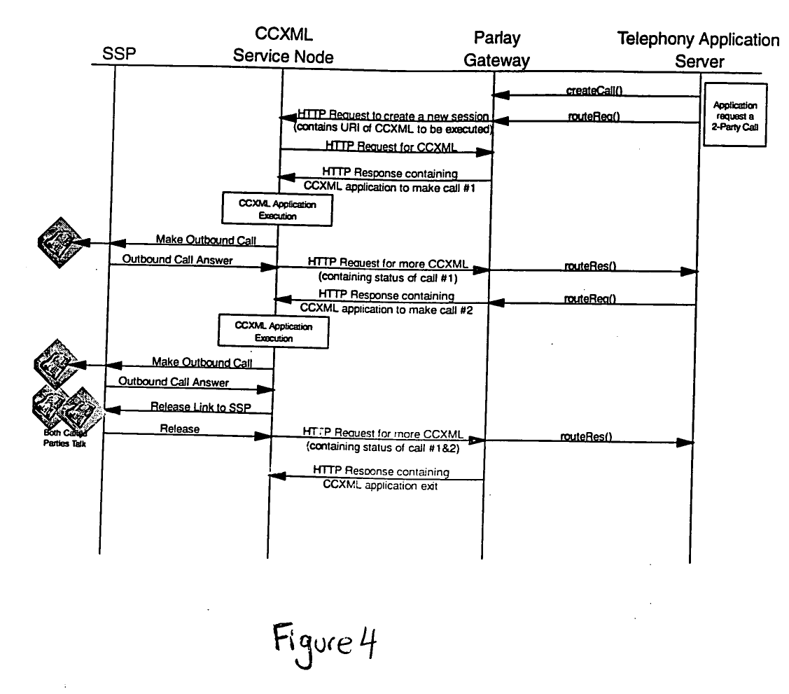

In order to provide additional flexibility to the system shown in FIG. 1 and reduce the demands made upon the service providers, the invention supplies the system shown FIG. 2. More specifically, this system includes a service node 200 and a server and parlay gateway combination 202. As explained in greater detail below with respect to FIGS. 3 and 4, the service node is adapted to forward a hypertext transfer protocol (HTTP) call control extensible markup language (CCXML) application request to the server and parlay gateway combination 202. The telephony application supplies a routing requirement to the server and parlay gateway combination 202. The server and parlay gateway combination 202 dynamically transforms the routing requirement into a CCXML routing application and the service node is adapted to execute the CCXML routing application to route the telephone call.

Further, the server and parlay gateway combination 202 can function in heterogeneous environments and work with different types of service nodes. The server portion 204 of the server and parlay gateway combination 202 comprises a HTTP server. Signaling transfer points can be connected to the service switching point; however, different than the system shown FIG. 1, in FIG. 2, communications between the signal switching point and the server and parlay gateway combination 202 bypass the signaling transfer point 102. The HTTP server and parlay gateway combination 202 connects to the service node using CCXML. This requires the HTTP server and parlay gateway combination 202 to act as a HTTP Server in response to HTTP requests for CCXML. The CCXML service node 200 connects to the SSP 100 using T1s or E1s and can use either SS7, ISDN or CAS signaling to communicate with the SSP 100.

The call flow in FIG. 3 shows an example of using the system in FIG. 2 for routing an inbound call using the CCXML service node 200. As shown by the first arrow in FIG. 3 (incoming call), the inbound call is routed to the CCXML service node 200 by the SSP 100. The CCXML service node 200 issues a HTTP request for CCXML to the HTTP server and parlay gateway combination 202 (HTTP request for CCXML). The HTTP server and parlay gateway combination 202 requests instruction from the Telephony Application Server 108 (calleventnotify) the telephony application server 108 responds with a routeReq( ) (This is a parlay message over CORBA/TCPIP) which the HTTP server and parlay gateway combination 202 dynamically transforms into a small CCXML script and sends the script to the CCXML service node 200 as a HTTP response (e.g., the HTTP response containing CCXML application to route call in FIG. 3). The CCXML script that is returned, is dynamically created based on the contents of the parlay message returned from the Telephony Application Server 108, such as routeReq( ).

The CCXML service node 200 executes the CCXML script which sets up an outbound call and releases the calling and called parties back to the SSP 100 (effectively routing the inbound call to the called party as shown by the arrows that make the outbound call, answer the outbound call, answer the incoming call, release the link, etc., in FIG. 3). The CCXML service node 200 then reports status back to the HTTP server and parlay gateway combination 202 by issuing another HTTP request with parameters (HTTP request for more CCXML (containing status of calls)). The HTTP server and parlay gateway combination 202 ends the call by returning a CCXML script containing an exit (last arrow in FIG. 3).

FIG. 4 shows an example of using the system in FIG. 2 for establishing a 2-Party outbound call from the telephony application server 108 using the HTTP server and parlay gateway combination 202 and CCXML service node 200. In this case the call is initiated by the telephony application server (as shown by the first arrow in FIG. 4). The telephony application server 108 sends a createCall( ) and routeReq( ) to the HTTP server and parlay gateway combination 202. The HTTP server and parlay gateway combination 202 issues a HTTP request to the CCXML service node 200 to start a new session (HTTP request to create a new session (contains URI of CCXML to be executed as shown in FIG. 4). The CCXML service node 200 responds back to the HTTP server and parlay gateway combination 202 with a HTTP request for a CCXML script (HTTP request for CCXML). As in the illustration shown in FIG. 3, the CCXML script is again built by the HTTP server and parlay gateway combination 202 dynamically, based on the Telephony Application Server's request. The remaining flow shown in FIG. 4 is substantially similar to the flow that is explained in detail in FIG. 3 where the service node 200 makes a HTTP request for a CCXML application, the application is returned, and executed by the service node. This is first performed for a call #1 and then for call #2 as shown in FIG. 4. The remaining processes are substantially similar to that discussed above with respect to FIG. 3.

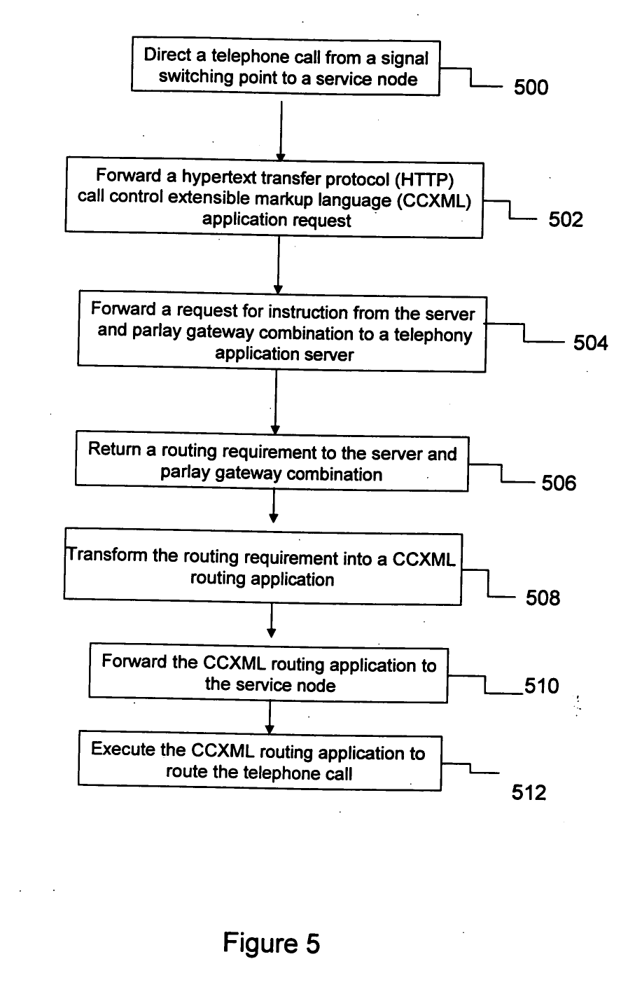

FIG. 5 is a flowchart of the inventive method of providing call control in a telephone network that begins by directing a telephone call from a signal switching point to a service node (500), forwarding a hypertext transfer protocol (HTTP) call control extensible markup language (CCXML) application request (502) from the service node to a server and parlay gateway combination, and forwarding a request for instruction (504) from the server and parlay gateway combination to a telephony application server. The telephony application returns a routing requirement (506) to the server and parlay gateway combination that, in turn, dynamically transforms the routing requirement into a CCXML routing application (508) and forwards the CCXML routing application to the service node (510). The service node executes the CCXML routing application to route the telephone call (512).

The foregoing shows how the call processing functionality required by a parlay gateway can be provided without relying on special functionality in the Service Provider's network through the use of a standard CCXML Service node. The CCXML Service node requires the Service provider to have only basic capabilities that are commonly available through all SSP vendors.

The solution provided by the invention allows a standard CCXML Service node to provide the call processing functionality required by a Parlay Gateway. The inventive system is not dependent on specific network equipment allowing it to function in heterogeneous environments. The invention does not require the Service provider to have any special functionality beyond their basic call processing capability. The invention is not dependent on a specific type of network signaling, SS7, ISDN or CAS can be used. The cost of the inventive system is lower when compared to conventional systems, because providing the call processing functionality required by a Parlay Gateway ubiquitously is very expensive. Further, it is easy to invoke VoiceXML from a CCXML environment, which significantly simplifies User Interaction as defined in Parlay. The CCXML Service node can be leveraged in other non-Parlay applications, further reducing the solution infrastructure costs. Additionally, with the invention it is easier to implement a Parlay Gateway with standard CCXML rather than having to support a large number of SS7/TCAP varients that are usually specific to the network equipment vendor and country of deployment. The Parlay Gateway of the invention is less complex and less expensive as it uses a standard TCP/IP interface rather than supporting multiple, redundant, physical SS7 links.

While the invention has been described in terms of preferred embodiments, those skilled in the art will recognize that the invention can be practiced with modification within the spirit and scope of the appended claims.

1. A system for providing call control in a telephone network, said system comprising:
a service node adapted to receive a telephone call;
a parlay gateway connected to said service node, wherein said service node is adapted to forward an application request to said parlay gateway;
a telephony application connected to said parlay gateway, said telephony application being adapted to supply a routing requirement to said parlay gateway,
wherein said parlay gateway is adapted to dynamically transform said routing requirement into a routing application, and
wherein said service node is adapted to execute said routing application to route said telephone call.

2. The system in claim 1, wherein said parlay gateway provides unique functionality that is independent of the call processing functionality of remaining elements of said telephone network.

3. The system in claim 1, wherein said parlay gateway functions in heterogeneous environments and works with different types of service nodes.

4. The system in claim 1, wherein said parlay gateway comprises a HTTP server.

5. The system in claim 1, further comprising a service switching point connected to said service node adapted to route said telephone call.

6. The system in claim 5, further comprising signaling transfer points connected to said service switching point, wherein communications between said service switching point and said parlay gateway bypass said signaling transfer points.

7. The system in claim 1, wherein said service node is adapted to report call status to said parlay gateway.

8. A system for providing call control in a telephone network, said system comprising:
a service node adapted to receive a telephone call;
a server and parlay gateway combination connected to said service node, wherein said service node is adapted to forward a hypertext transfer protocol (HTTP) call control extensible markup language (CCXML) application request to said server and parlay gateway combination;
a telephony application connected to said server and parlay gateway combination, said telephony application being adapted to supply a routing requirement to said server and parlay gateway combination,
wherein said server and parlay gateway combination is adapted to dynamically transform said routing requirement into a CCXML routing application,
wherein said service node is adapted to execute said CCXML routing application to route said telephone call.

9. The system in claim 8, wherein said server and parlay gateway combination provides unique functionality that is independent of the call processing functionality of remaining elements of said telephone network.

10. The system in claim 8, wherein said server and parlay gateway combination functions in heterogeneous environments and works with different types of service nodes.

11. The system in claim 8, wherein the server portion of said server and parlay gateway combination comprises a HTTP server.

12. The system in claim 8, further comprising a service switching point connected to said service node adapted to route said telephone call.

13. The system in claim 12, further comprising signaling transfer points connected to said service switching point, wherein communications between said service switching point and said server and parlay gateway combination bypass said signaling transfer points.

14. The system in claim 8, wherein said service node is adapted to report call status to said server and parlay gateway combination.

15. A method of providing call control in a telephone network, said method comprising:
directing a telephone call to a service node;
forwarding an application request from said service node to a parlay gateway;
forwarding a request for instruction from said parlay gateway to a telephony application server;
returning a routing requirement from said telephony application server to said parlay gateway;
dynamically transforming said routing requirement into a routing application using said parlay gateway;
forwarding said routing application from said parlay gateway to said service node;
executing said routing application using said service node; and
routing said telephone call based on results of said routing application.

16. The method in claim 15, wherein said parlay gateway provides unique functionality that is independent of the call processing functionality of remaining elements of said telephone network.

17. The method in claim 15, wherein said parlay gateway functions in heterogeneous environments and works with different types of service nodes.

18. The method in claim 15, wherein said parlay gateway comprises a HTTP server.

19. The method in claim 15, wherein said routing of said telephone call is performed using a service switching point connected to said service node.

20. The method in claim 19, wherein communications between said service switching point and said parlay gateway bypass signaling transfer points.

21. The method in claim 15, further comprising reporting call status from said service node to said parlay gateway.

22. A method of providing call control in a telephone network, said method comprising:
directing a telephone call to a service node;
forwarding a hypertext transfer protocol (HTTP) call control extensible markup language (CCXML) application request from said service node to a server and parlay gateway combination;
forwarding a request for instruction from said server and parlay gateway combination to a telephony application server;
returning a routing requirement from said telephony application server to said server and parlay gateway combination;
dynamically transforming said routing requirement into a CCXML routing application using said server and parlay gateway combination;
forwarding said CCXML routing application from said server and parlay gateway combination to said service node;
executing said CCXML routing application using said service node; and
routing said telephone call based on results of said CCXML routing application.

23. The method in claim 22, wherein said server and parlay gateway combination provides unique functionality that is independent of the call processing functionality of remaining elements of said telephone network.

24. The method in claim 22, wherein said server and parlay gateway combination functions in heterogeneous environments and works with different types of service nodes.

25. The method in claim 22, wherein the server portion of said server and parlay gateway combination comprises a HTTP server.

26. The method in claim 22, wherein said routing of said telephone call is performed using a service switching point connected to said service node.

27. The method in claim 26, wherein communications between said service switching point and said server and parlay gateway combination bypass signaling transfer points.

28. The method in claim 22, further comprising reporting call status from said service node to said server and parlay gateway combination.
